(19) United States
(12) Patent Application Publication
(10) Pub. No.: US 2018/0001716 A1
(43) Pub. Date: Jan. 4, 2018

(54) Protective Barrier for Tires and Application Thereof

(71) Applicants: Compagnie Generale des Etablissements Michelin, Clermont-Ferrand (FR); Michelin Recherche Et Technique S.A., Granges-Paccot (CH); The Texas A&M University System, College Station, TX (US)

(72) Inventors: Jaime C. Grunlan, College Station, TX (US); Paul Winston, Greenville, SC (US); Olivier Piffard, Greenville, SC (US); Xavier Saintigny, Greenville, SC (US); Morgan Priolo, Woodbury, MN (US)

(21) Appl. No.: 15/538,826

(22) PCT Filed: Dec. 23, 2014
(86) PCT No.: PCT/US14/72041

§ 371 Date: Jun. 22, 2017

(51) Int. Cl. B60C 13/00; B60C 1/00; B60C 19/00; C08L 71/02; C08L 79/02; C09D 171/02; C08K 3/20

(52) U.S. Cl. CPC B60C 13/002; B60C 19/00; B60C 1/00; C08K 3/20; C08L 79/02; C09D 171/02; C08L 71/02

(57) ABSTRACT

A tire has a material diffusion barrier, and a method produces the same. In an embodiment, a method for producing a material diffusion barrier on a tire comprises exposing a surface of the tire to a cationic solution to produce a cationic layer on the surface. The method further comprises exposing the cationic layer to an anionic solution to produce an anionic layer on the cationic layer, wherein a layer comprises the cationic layer and the anionic layer. The layer comprises the material diffusion barrier.

### BACKGROUND OF THE INVENTION

### Field of the Invention

This invention relates to the field of diffusion barriers and more specifically to the use and application of thin film barriers for tires to prevent the diffusion of materials across said thin film barrier.

### Background of the Invention

Diffusion barriers to gas and vapors are key components in a variety of applications, such as food packaging and flexible electronics. However, such barriers have typically not been used to protect tires during transport and storage. Tires are often stored for long periods of time before purchase and use. During this storage interval, damaging gases such as oxygen and ozone, as well as fluids or moisture from the air, may seep into the tire and cause damage. Additionally, such gases and fluids may consume the anti-degradants added to the tire, which may be used for extending tire life. Previous protective measures have included the use of polyvinyl alcohol. However, polyvinyl alcohol typically only protects against tire scuffing and may not prevent gas or liquid diffusion. Moreover, the application of polyvinyl alcohol is typically only used to protect the whitewalls of the tire and is typically not applied to the tread, interior, grooves, and the like. Further, many manufacturers simply do nothing as a practical way to prevent gas and fluid diffusion for tires. If no protection is used, the tire may experience damage and premature degradation, which may decrease the life of the tire and add costs to the consumer and reduce consumer confidence in the manufacturer.

Consequently, there is a need for a diffusion barrier for tires. There is also a further need for a practical application of a diffusion barrier for a tire.

### BRIEF SUMMARY OF SOME OF THE PREFERRED EMBODIMENTS

These and other needs in the art are addressed in one embodiment by a method for producing a material diffusion barrier on a tire. The method comprises exposing a surface of the tire to a cationic solution to produce a cationic layer on the surface. The method further comprises exposing the cationic layer to an anionic solution to produce an anionic layer on the cationic layer, wherein a layer comprises the cationic layer and the anionic layer. The layer comprises the material diffusion barrier.

These and other needs in the art are addressed by another embodiment of a method for producing a material diffusion barrier on a tire. The method includes exposing a surface of the tire to an anionic solution to produce an anionic layer on the surface. The method also includes exposing the anionic layer to a cationic solution to produce a cationic layer on the anionic layer. A layer includes the anionic layer and the cationic layer. The layer includes the material diffusion barrier.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a quadlayer on a rubber substrate;

FIG. 2 illustrates an embodiment of a quadlayer, a rubber substrate, and a primer layer;

FIG. 3 illustrates an embodiment of three quadlayers and a rubber substrate;

FIG. 4 illustrates thickness as a function of the number of quadlayers;

FIG. 5 illustrates oxygen transmission rate as a function of the number of quadlayers;

FIG. 6 illustrates images of elasticity of coating;

FIG. 7 illustrates an embodiment of a bilayer on a rubber substrate;

FIG. 8 illustrates an embodiment of bilayers of layerable materials and additives;

FIG. 9 illustrates an embodiment of bilayers with alternating layers of layerable materials and additives; and

FIG. 10 illustrates an embodiment with bilayers of layerable materials and additives.

### DETAILED DESCRIPTION OF THE PREFERRED EMBODIMENTS

In an embodiment, a multilayer thin film coating method provides a rubber substrate, e.g., a tire or materials used in the manufacturer of tires, with a gas and fluid diffusion retardant coating by alternately depositing positive and negative charged layers on the substrate. Each pair of positive and negative layers comprises a layer. In embodiments, the multilayer thin film coating method produces any number of desired layers on substrates such as bilayers, trilayers, quadlayers, pentalayers, hexalayers, heptalayers, octalayers, and increasing layers. Without limitation, a layer or plurality of layers may provide a desired yield. Further, without limitation, a plurality of layers may provide a desired retardant to transmission of material through the rubber substrate. The material may be any diffusible material. Without limitation, the diffusible material may be a solid, a fluid, or any combinations thereof. The fluid may be any diffusible fluid such as a liquid, a gas, or any combinations thereof. In an embodiment, the diffusible fluid is a gas.

The positive and negative layers may have any desired thickness. In embodiments, each layer is between about 0.5 nanometers and about 100 nanometers thick, alternatively between about 1 nanometer and about 100 nanometers thick, and alternatively between about 0.5 nanometers and about 10 nanometers thick. In some embodiments of the multilayer thin film coating method, one or more of the positive layers are neutral rather than positively charged.

Any desirable rubber substrate may be coated with the multilayer thin film coating method. The rubber substrate may include any rubber substrate that is used as a tire or may potentially be used in the manufacture of tires. Without limitation, examples of suitable rubbers include natural rubber and synthetic rubber. In an embodiment, natural rubber comprises polyisoprene. In embodiments, synthetic rubbers include polychloroprene, butadiene-styrene copolymers, acrylonitrilebutadiene copolymers, ethylenepropylene-diene rubbers, polysulfide rubber, nitrile rubber, silicone, polyurethane, butyl rubber, or any combinations thereof. In an embodiment, the synthetic rubber comprises butyl rubber. In some embodiments, the rubber comprises a carbon black filled natural rubber formulation vulcanized with sulfur. In embodiments, the multilayer thin film coating may be applied to both pneumatic and non-pneumatic tires.

The negative charged (anionic) layers comprise layerable materials. In some embodiments, one or more anionic layers may be neutral. The layerable materials include anionic polymers, colloidal particles, or any combinations thereof. Without limitation, examples of suitable anionic polymers include polystyrene sulfonate, polymethacrylic acid, polyacrylic acid, poly(acrylic acid, sodium salt), polyanetholesulfonic acid sodium salt, poly(vinylsulfonic acid, sodium salt), or any combinations thereof. In addition, without limitation, colloidal particles include organic and/or inorganic materials. Further, without limitation, examples of colloidal particles include clays, colloidal silica, inorganic hydroxides, silicon based polymers, polyoligomeric silsesquioxane, carbon nanotubes, graphene, or any combinations thereof. Any type of clay suitable for use in an anionic solution may be used. Without limitation, examples of suitable clays include sodium montmorillonite, hectorite, saponite, Wyoming bentonite, vermiculite, halloysite, or any combinations thereof. In an embodiment, the clay is sodium montmorillonite. Any inorganic hydroxide that may provide retardancy to gas or vapor transmission may be used. In an embodiment, the inorganic hydroxide includes aluminum hydroxide, magnesium hydroxide, or any combinations thereof.

The positive charge (cationic) layers comprise cationic materials. In some embodiments, one or more cationic layers may be neutral. The cationic materials comprise polymers, colloidal particles, nanoparticles, or any combinations thereof. The polymers include cationic polymers, polymers with hydrogen bonding, or any combinations thereof. Without limitation, examples of suitable cationic polymers include branched polyethylenimine, linear polyethylenimine, cationic polyacrylamide, cationic poly diallyldimethylammonium chloride, poly(allyl amine), poly(allyl amine) hydrochloride, poly(vinyl amine), poly(acrylamide-co-diallyldimethylammonium chloride), or any combinations thereof. Without limitation, examples of suitable polymers with hydrogen bonding include polyethylene oxide, polyglycidol, polypropylene oxide, poly(vinyl methyl ether), polyvinyl alcohol, polyvinylpyrrolidone, polyallylamine, branched polyethylenimine, linear polyethylenimine, poly(acrylic acid), poly(methacrylic acid), copolymers thereof, or any combinations thereof. In embodiments, the polymers with hydrogen bonding are neutral polymers. In addition, without limitation, colloidal particles include organic and/or inorganic materials. Further, without limitation, examples of colloidal particles include clays, layered double hydroxides, inorganic hydroxides, silicon based polymers, polyoligomeric silsesquioxane, carbon nanotubes, graphene, or any combinations thereof. Without limitation, examples of suitable layered double hydroxides include hydrotalcite, magnesium LDH, aluminum LDH, or any combinations thereof.

In embodiments, the positive (or neutral) and negative (or neutral) layers are deposited on the rubber substrate by any suitable method. Embodiments include depositing the positive (or neutral) and negative (or neutral) layers on the rubber substrate by any suitable deposition method. Without limitation, examples of suitable methods include bath coating, spray coating, slot coating, spin coating, curtain coating, gravure coating, reverse roll coating, knife over roll (i.e., gap) coating, metering (Meyer) rod coating, air knife coating, or any combinations thereof. Bath coating includes immersion or dip. In an embodiment, the positive (or neutral) and negative (or neutral) layers are deposited by bath. In other embodiments, the positive and negative layers are deposited by spray. The positive and negative layers may be sprayed using any suitable spraying mechanism and nozzle. In alternative embodiments, the positive and negative layers may be made into a protective coating sheet or roll and then transferred to the tire. Once transferred, the protective coating may be shrunk or vacuum wrapped around the tire. In some embodiments, the positive and negative layers may be deposited on every surface of the tire. For example, the positive and negative layers may be deposited on the exterior of the tire, the interior of the tire, the sidewalls of the tire, the tread of the tire, the grooves between the tread of the tire, and the like. It is to be understood that coating most or all surfaces of the tire, decreases the surface area of the tire available for gas and/or fluid migration into the tire. For instance, the entire tire may be dipped in a bath of a cationic or layerable material such that every exposed surface may be coated with said cationic or layerable material. Without limitation, coating the inside of the tire, which in some embodiments may be where the tire bladder is disposed, allows for air pressure in the tire to be maintained normally within the tire, with little to no exposure by air, oxygen, ozone, and the like.

In embodiments, the multilayer thin film coating may be used to prevent migration of gases and fluids into the tire. Examples of gases which may be blocked from diffusing into the tire include air, oxygen, ozone, water vapor, and the like. Examples of fluids that may be blocked from diffusing into the tire include water and the like. Without limitation by theory, the multilayer thin film coating may form a barrier to gases and fluids such that most if not all gases or fluids are unable to diffuse into the substrate coated with the multilayer thin film coating. Further, when used to protect tires, anti-degradants such as various waxes or antioxidants such as N-(1,3-dimethylbutyl)-N′-phenyl-p-phenylenediamine (“6PPD”); 2,2,4-trimethyl-1,2-dihydroquinoline (“TMQ”); N-isopropyl-N′-phenyl-p-phenylenediamine (“IPPD”); or 6-ethoxy-2,2,4-trimethyl-1,2-dihydroquinoline (“ETMQ”); may be protected from consumption by oxidants, ozonants, and the like. These anti-degradants may then themselves possess a longer shelf life when protected by the multilayer thin film coating. Once the tires have been sold, the multilayer thin film coating may be rubbed or washed with use over time, allowing the anti-degradants to migrate to the surface of the tire to initiate their normal functionality.

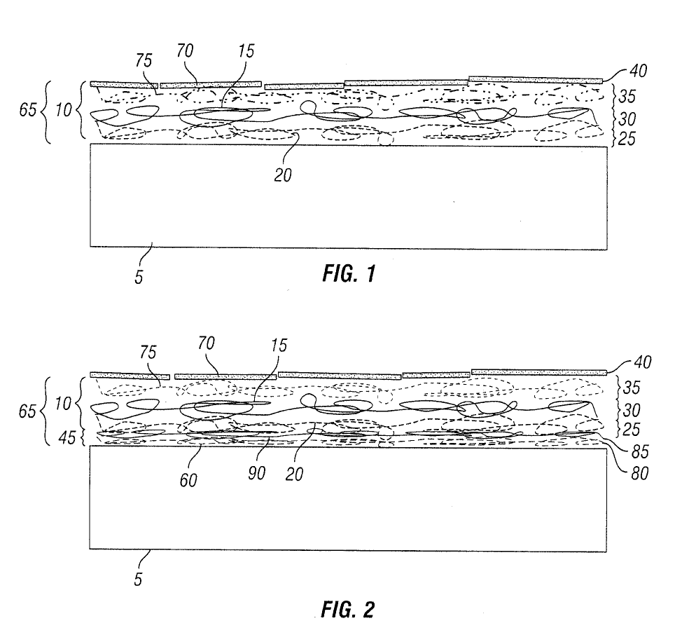

In some embodiments, the multilayer thin film coating method may provide two pairs of positive and negative layers, which two pairs comprise a quadlayer. Embodiments include the multilayer thin film coating method producing a plurality of quadlayers on a rubber substrate. FIG. 1 illustrates an embodiment of a rubber substrate 5, for example a tire, with coating 65 of quadlayer 10. In an embodiment to produce the coated rubber substrate 5 shown in FIG. 1, the multilayer thin film coating method includes exposing rubber substrate 5 to cationic molecules in a cationic mixture to produce first cationic layer 25 on rubber substrate 5. The cationic mixture contains first layer cationic materials 20. In an embodiment, first layer cationic materials 20 are positively charged or neutral. In embodiments, first layer cationic materials 20 are neutral. In some embodiments, first layer cationic materials 20 are polymers with hydrogen bonding having a neutral charge. Embodiments include first layer cationic materials 20 comprising polyethylene oxide. Without limitation, first layer cationic materials 20 comprising neutral materials (i.e., polyethylene oxide) may provide a desired yield. In such an embodiment, rubber substrate 5 is negatively charged or neutral. Embodiments include rubber substrate 5 having a negative charge. Without limitation, a negatively charged rubber substrate 5 provides a desired adhesion. The cationic mixture includes an aqueous solution of first layer cationic materials 20. The aqueous solution may be prepared by any suitable method. In embodiments, the aqueous solution includes first layer cationic materials 20 and water. In other embodiments, first layer cationic materials 20 may be dissolved in a mixed solvent, in which one of the solvents is water and the other solvent is miscible with water (e.g., water, methanol, and the like). The solution may also contain colloidal particles in combination with polymers or alone, if positively charged. Any suitable water may be used. In embodiments, the water is deionized water. In some embodiments, the aqueous solution may include from about 0.05 wt. % first layer cationic materials 20 to about 1.50 wt. % first layer cationic materials 20, alternatively from about 0.01 wt. % first layer cationic materials 20 to about 2.00 wt. % first layer cationic materials 20, and further alternatively from about 0.001 wt. % first layer cationic materials 20 to about 20.0 wt. % first layer cationic materials 20. In embodiments, rubber substrate 5 may be exposed to the cationic mixture for any suitable period of time to produce first cationic layer 25. In embodiments, rubber substrate 5 is exposed to the cationic mixture from about 1 second to about 20 minutes, alternatively from about 1 second to about 200 seconds, and alternatively from about 10 seconds to about 200 seconds, and further alternatively from about instantaneous to about 1,200 seconds. Without limitation, the exposure time of rubber substrate 5 to the cationic mixture and the concentration of first layer cationic materials 20 in the cationic mixture affect the thickness of first cationic layer 25. For instance, the higher the concentration of first layer cationic materials 20 and the longer the exposure time, the thicker the first cationic layer 25 produced by the multilayer thin film coating method.

In embodiments, after formation of first cationic layer 25, multilayer thin film coating method includes removing rubber substrate 5 with the produced first cationic layer 25 from the cationic mixture and then exposing rubber substrate 5 with first cationic layer 25 to anionic molecules in an anionic mixture to produce first anionic layer 30 on first cationic layer 25. The anionic mixture contains first layer layerable materials 15. Without limitation, the positive or neutral first cationic layer 25 attracts the anionic molecules to form the cationic(or neutral)-anionic pair of first cationic layer 25 and first anionic layer 30. The anionic mixture includes an aqueous solution of first layer layerable materials 15. In an embodiment, first layer layerable materials 15 comprise polyacrylic acid. The aqueous solution may be prepared by any suitable method. In embodiments, the aqueous solution includes first layer layerable materials 15 and water. First layer layerable materials 15 may also be dissolved in a mixed solvent, in which one of the solvents is water and the other solvent is miscible with water (e.g., ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % first layer layerable materials 15 to about 1.50 wt. % first layer layerable materials 15, alternatively from about 0.01 wt. % first layer layerable materials 15 to about 2.00 wt. % first layer layerable materials 15, and further alternatively from about 0.001 wt. % first layer layerable materials 15 to about 20.0 wt. % first layer layerable materials 15. In embodiments, rubber substrate 5 with first cationic layer 25 may be exposed to the anionic mixture for any suitable period of time to produce first anionic layer 30. In embodiments, rubber substrate 5 with first cationic layer 25 is exposed to the anionic mixture from about 1 second to about 20 minutes, alternatively from about 1 second to about 200 seconds, and alternatively from about 10 seconds to about 200 seconds, and further alternatively from about instantaneous to about 1,200 seconds. Without limitation, the exposure time of rubber substrate 5 with first cationic layer 25 to the anionic mixture and the concentration of first layer layerable materials 15 in the anionic mixture affect the thickness of the first anionic layer 30. For instance, the higher the concentration of first layer layerable materials 15 and the longer the exposure time, the thicker the first anionic layer 30 produced by the multilayer thin film coating method.

In embodiments as further shown in FIG. 1, after formation of first anionic layer 30, the multilayer thin film coating method includes removing rubber substrate 5 with the produced first cationic layer 25 and first anionic layer 30 from the anionic mixture and then exposing rubber substrate 5 with first cationic layer 25 and first anionic layer 30 to cationic molecules in a cationic mixture to produce second cationic layer 35 on first anionic layer 30. The cationic mixture contains second layer cationic materials 75. In an embodiment, second layer cationic materials 75 are positively charged or neutral. In embodiments, second layer cationic materials 75 are positive. In some embodiments, second layer cationic materials 75 comprise polyethylenimine, which, in some embodiments, may include branched polyethyleneimine. The cationic mixture includes an aqueous solution of second layer cationic materials 75. The aqueous solution may be prepared by any suitable method. In embodiments, the aqueous solution includes second layer cationic materials 75 and water. In other embodiments, second layer cationic materials 75 may be dissolved in a mixed solvent, in which one of the solvents is water and the other solvent is miscible with water (e.g., water, methanol, and the like). The solution may also contain colloidal particles in combination with polymers or alone, if positively charged. Any suitable water may be used. In embodiments, the water is deionized water. In some embodiments, the aqueous solution may include from about 0.05 wt. % second layer cationic materials 75 to about 1.50 wt. % second layer cationic materials 75, alternatively from about 0.01 wt. % second layer cationic materials 75 to about 2.00 wt. % second layer cationic materials 75, and further alternatively from about 0.001 wt. % second layer cationic materials 75 to about 20.0 wt. % second layer cationic materials 75. In embodiments, rubber substrate 5 may be exposed to the cationic mixture for any suitable period of time to produce second cationic layer 35. In embodiments, rubber substrate 5 is exposed to the cationic mixture from about 1 second to about 20 minutes, alternatively from about 1 second to about 200 seconds, and alternatively from about 10 seconds to about 200 seconds, and further alternatively from about instantaneous to about 1,200 seconds. In embodiments, after formation of the second cationic layer 35, multilayer thin film coating method includes removing rubber substrate 5 with the produced first cationic layer 25, first anionic layer 30, and second cationic layer 35 from the cationic mixture and then exposing rubber substrate 5 with first cationic layer 25, first anionic layer 30, and second cationic layer 35 to anionic molecules in an anionic mixture to produce second anionic layer 40 on second cationic layer 35. The anionic mixture contains second layer layerable materials 70. Without limitation, the positive or neutral second cationic layer 35 attracts the anionic molecules to form the cationic(or neutral)-anionic pair of second cationic layer 35 and second anionic layer 40. The anionic mixture includes an aqueous solution of second layer layerable materials 70. In an embodiment, second layer layerable materials 70 comprise clay. Embodiments include a clay. In some embodiments, the clay may comprise sodium montmorillonite. The aqueous solution may be prepared by any suitable method. In embodiments, the aqueous solution includes second layer layerable materials 70 and water. Second layer layerable materials 70 may also be dissolved in a mixed solvent, in which one of the solvents is water and the other solvent is miscible with water (e.g., ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % second layer layerable materials 70 to about 1.50 wt. % second layer layerable materials 70, alternatively from about 0.01 wt. % second layer layerable materials 70 to about 2.00 wt. % second layer layerable materials 70, and further alternatively from about 0.001 wt. % second layer layerable materials 70 to about 20.0 wt. % second layer layerable materials 70. In embodiments, rubber substrate 5 with first cationic layer 25, first anionic layer 30, and second cationic layer 35 may be exposed to the anionic mixture for any suitable period of time to produce second anionic layer 40. In embodiments, rubber substrate 5 with first cationic layer 25, first anionic layer 30, and second cationic layer 35 is exposed to the anionic mixture from about 1 second to about 20 minutes, alternatively from about 1 second to about 200 seconds, and alternatively from about 10 seconds to about 200 seconds, and further alternatively from about instantaneous to about 1,200 seconds. Quadlayer 10 is therefore produced on rubber substrate 5. In embodiments as shown in FIG. 1 in which rubber substrate 5 has one quadlayer 10, coating 65 comprises quadlayer 10. In embodiments, quadlayer 10 comprises first cationic layer 25, first anionic layer 30, second cationic layer 35, and second anionic layer 40.

In an embodiment as shown in FIG. 2, coating 65 also comprises primer layer 45. Primer layer 45 is disposed between the surface of rubber substrate 5 (e.g., a tire) and first cationic layer 25 of quadlayer 10. Primer layer 45 may have any number of layers. The layer of primer layer 45 proximate to rubber substrate 5 has a charge with an attraction to rubber substrate 5, and the layer of primer layer 45 proximate to first cationic layer 25 has a charge with an attraction to first cationic layer 25. In embodiments as shown in FIG. 2, primer layer 45 is a bilayer having a first primer layer 80 and a second primer layer 85. In such embodiments, first primer layer 80 is a cationic layer (or alternatively neutral) comprising first primer layer materials 60, and second primer layer 85 is an anionic layer comprising second primer layer materials 90. First primer layer materials 60 comprise cationic materials. In an embodiment, first primer layer materials 60 comprise polyethylenimine. Second primer layer materials 90 comprise layerable materials. In an embodiment, second primer layer materials 90 comprise polyacrylic acid. In other embodiments (not shown), primer layer 45 has more than one bilayer.

In further embodiments as shown in FIG. 2, the multilayer thin film coating method includes exposing rubber substrate 5 to cationic molecules in a cationic mixture to produce first primer layer 80 on rubber substrate 5. The cationic mixture contains first primer layer materials 60. In an embodiment, first primer layer materials 60 are positively charged or neutral. In embodiments, the cationic mixture includes an aqueous solution of first primer layer materials 60. The aqueous solution may be prepared by any suitable method. In embodiments, the aqueous solution includes first primer layer materials 60 and water. In other embodiments, first primer layer materials 60 may be dissolved in a mixed solvent, in which one of the solvents is water and the other solvent is miscible with water (e.g., water, methanol, and the like). The solution may also contain colloidal particles in combination with polymers or alone, if positively charged. Any suitable water may be used. In embodiments, the water is deionized water. In some embodiments, the aqueous solution may include from about 0.05 wt. % first primer layer materials 60 to about 1.50 wt. % first primer layer materials 60, alternatively from about 0.01 wt. % first primer layer materials 60 to about 2.00 wt. % first primer layer materials 60, and further alternatively from about 0.001 wt. % first primer layer materials 60 to about 20.0 wt. % first primer layer materials 60. In embodiments, rubber substrate 5 may be exposed to the cationic mixture for any suitable period of time to produce first primer layer 80. In embodiments, rubber substrate 5 is exposed to the cationic mixture from about 1 second to about 20 minutes, alternatively from about 1 second to about 200 seconds, and alternatively from about 10 seconds to about 200 seconds, and further alternatively from about instantaneous to about 1,200 seconds.

In embodiments as shown in FIG. 2, after formation of first primer layer 80, multilayer thin film coating method includes removing rubber substrate 5 with the produced first primer layer 80 from the cationic mixture and then exposing rubber substrate 5 with first primer layer 80 to anionic molecules in an anionic mixture to produce second primer layer 85 on first primer layer 80. The anionic mixture contains second primer layer materials 90. The anionic mixture includes an aqueous solution of second primer layer materials 90. The aqueous solution may be prepared by any suitable method. In embodiments, the aqueous solution includes second primer layer materials 90 and water. Second primer layer materials 90 may also be dissolved in a mixed solvent, in which one of the solvents is water and the other solvent is miscible with water (e.g., ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % second primer layer materials 90 to about 1.50 wt. % second primer layer materials 90, alternatively from about 0.01 wt. % second primer layer materials 90 to about 2.00 wt. % second primer layer materials 90, and further alternatively from about 0.001 wt. % second primer layer materials 90 to about 20.0 wt. % second primer layer materials 90. In embodiments, the rubber substrate 5 with first primer layer 80 may be exposed to the anionic mixture for any suitable period of time to produce second primer layer 85. In embodiments, rubber substrate 5 with first primer layer 80 is exposed to the anionic mixture from about 1 second to about 20 minutes, alternatively from about 1 second to about 200 seconds, and alternatively from about 10 seconds to about 200 seconds, and further alternatively from about instantaneous to about 1,200 seconds. Rubber substrate 5 with primer layer 45 is then removed from the anionic mixture and then the multilayer thin film coating method proceeds to produce quadlayer 10.

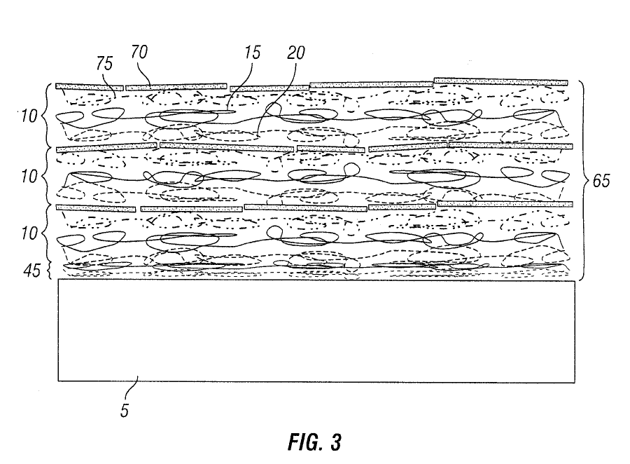

In embodiments as shown in FIG. 3, the exposure steps are repeated with substrate 5 having quadlayer 10 continuously exposed to the cationic mixture and then the anionic mixture to produce a coating 65 having multiple quadlayers 10. The repeated exposure to the cationic mixture and then the anionic mixture may continue until the desired number of quadlayers 10 is produced. Coating 65 may have any sufficient number of quadlayers 10 to provide a rubber substrate 5 (e.g., a tire) with a desired retardant to gas or vapor transmission. In an embodiment, coating 65 has between about 1 quadlayer 10 and about 40 quadlayers 10, alternatively between about 1 quadlayer 10 and about 1,000 quadlayers 10.

In an embodiment, the multilayer thin film coating method provides a coated rubber substrate 5 (e.g., comprising coating 65) with a yield between about 0.1% and about 100%, alternatively between about 1% and about 10%. In addition, embodiments include the multilayer thin film coating method providing a coated rubber substrate 5 having a gas transmission rate between about 0.03 cc/(m²*day*atm) and about 100 cc/(m²*day*atm), alternatively between about 0.3 cc/(m²*day*atm) and about 100 cc/(m²*day*atm), and alternatively between about 3 cc/(m²*day*atm) and about 30 cc/(m²*day*atm).

It is to be understood that the multilayer thin film coating method is not limited to exposure to a cationic mixture followed by an anionic mixture. In embodiments in which rubber substrate 5 is positively charged (or neutral), the multilayer thin film coating method includes exposing rubber substrate 5 to the anionic mixture followed by exposure to the cationic mixture. In such embodiment (not illustrated), first anionic layer 30 is deposited on rubber substrate 5 with first cationic layer 25 deposited on first anionic layer 30, and second anionic layer 40 is deposited on first cationic layer 25 followed by second cationic layer 35 deposited on second anionic layer 40 to produce quadlayer 10 with the steps repeated until coating 65 has the desired thickness. In embodiments in which rubber substrate 5 has a neutral charge, the multilayer thin film coating method may include beginning with exposure to the cationic mixture followed by exposure to the anionic mixture or may include beginning with exposure to the anionic mixture followed by exposure to the cationic mixture.

In embodiments (not shown), quadlayers 10 may have one or more than one cationic layer (i.e., first cationic layer 25, second cationic layer 35, cationic layers in primer layer 45) comprised of more than one type of cationic materials. In an embodiment (not shown), quadlayers 10 may have one or more than one anionic layer (i.e., first anionic layer 30, second anionic layer 40, anionic layers in primer layer 45) comprised of more than one type of anionic material. In some embodiments, one or more cationic layers are comprised of the same materials, and/or one or more of the anionic layers are comprised of the same anionic materials. It is to be understood that coating 65 is not limited to one layerable material but may include more than one layerable material and/or more than one cationic material.

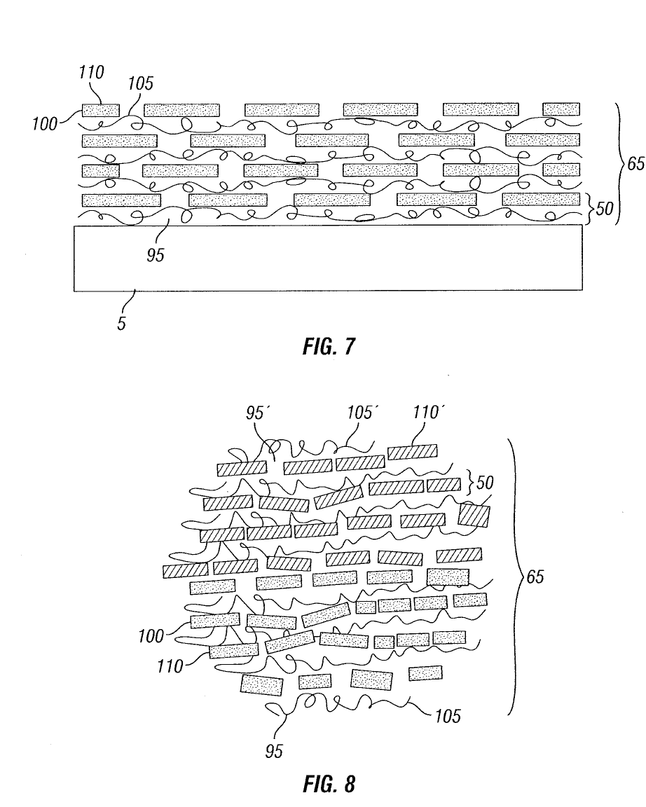

FIG. 7 illustrates an embodiment of rubber substrate 5 (e.g., a tire) with coating 65 of multiple bilayers 50. It is to be understood that the multilayer thin film coating method produces the coated rubber substrate 5 by the embodiments set forth above and shown in FIGS. 1-3. As shown in FIG. 7, each bilayer 50 has cationic layer 95 and anionic layer 100. In embodiments as shown, cationic layer 95 has cationic materials 105, and anionic layer 100 has layerable materials 110. In the embodiment as shown, the multilayer thin film coating method produces coating 65 by exposure to a cationic mixture followed by an anionic mixture according to the embodiments above. In an embodiment, bilayer 50 has cationic materials 105 comprising polyethylene oxide or polyglycidol, and layerable materials 110 comprising clay. In some embodiments, bilayer 50 has cationic materials 105 comprising polyethylene oxide or polyglycidol, and layerable materials 110 comprising polyacrylic acid or polymethacrylic acid.

It is to be understood that the multilayer thin film coating method for preparing an rubber substrate 5 with coating 65 having bilayers 50 is not limited to exposure to a cationic mixture followed by an anionic mixture. In embodiments in which rubber substrate 5 is positively charged, the multilayer thin film coating method includes exposing rubber substrate 5 to the anionic mixture followed by exposure to the cationic mixture. In such embodiment (not illustrated), anionic layer 100 is deposited on rubber substrate 5 with cationic layer 95 deposited on anionic layer 100 to produce bilayer 50 with the steps repeated until coating 65 has the desired thickness. In embodiments in which rubber substrate 5 has a neutral charge, the multilayer thin film coating method may include beginning with exposure to the cationic mixture followed by exposure to the anionic mixture or may include beginning with exposure to the anionic mixture followed by exposure to the cationic mixture.

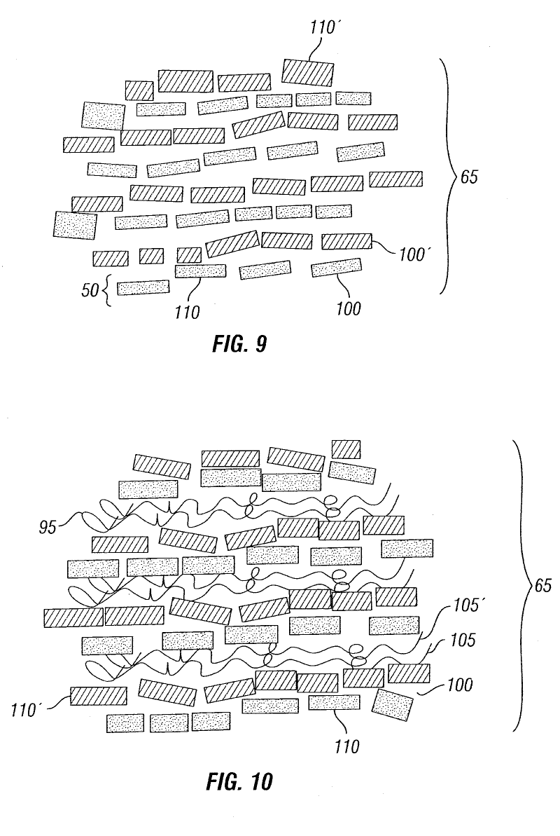

It is to be further understood that coating 65 is not limited to one layerable material 110 and/or one cationic material 105 but may include more than one layerable material 110 and/or more than one cationic material 105. The different layerable materials 110 may be disposed on the same anionic layer 100, alternating anionic layers 100, or in layers of bilayers 50 (i.e., or in layers of trilayers or increasing layers). The different cationic materials 105 may be dispersed on the same cationic layer 95, alternating cationic layers 95, or in layers of bilayers 50 (i.e., or in layers of trilayers or increasing layers). For instance, in embodiments as illustrated in FIGS. 8-10, coating 65 includes two types of layerable materials 110, 110′ (i.e., sodium montmorillonite is layerable material 110 and aluminum hydroxide is layerable material 110′). It is to be understood that rubber substrate 5 (e.g., a tire) is not shown for illustrative purposes only in FIGS. 8-10. FIG. 8 illustrates an embodiment in which layerable materials 110, 110′ are in different layers of bilayers 50. For instance, as shown in FIG. 8, layerable materials 110′ are deposited in the top bilayers 50 after layerable materials 110 are deposited on rubber substrate 5 (not illustrated). FIG. 9 illustrates an embodiment in which coating 65 has layerable materials 110, 110′ in alternating bilayers 50. It is to be understood that cationic materials 105 are not shown for illustrative purposes only in FIG. 9. FIG. 10 illustrates an embodiment in which there are two types of bilayers 50, comprised of particles (layerable materials 110, 110′) and cationic materials 105, 105′ (e.g., polymers).

FIGS. 7-10 do not show coating 65 having primer layer 45. It is to be understood that embodiments of coating 65 having bilayers 50 also may have primer layer 45. Embodiments (not illustrated) of coating 65 having trilayers, pentalayers, and the like may also have primer layer 45.

It is to be understood that the multilayer thin film coating method produces coatings 65 of trilayers, pentalayers, and increasing layers by the embodiments disclosed above for bilayers 50 and quadlayers 10. It is to be understood that coating 65 is not limited to only a plurality of bilayers 50, trilayers, quadlayers 10, pentalayers, hexalayers, heptalayers, octalayers, or increasing layers. In embodiments, coating 65 may have any combination of such layers.

In some embodiments in which coating 65 comprises trilayers, the trilayers comprise a first cationic layer comprising polyethylenimine, a second cationic layer comprising polyethylene oxide or polyglycidol, and an anionic layer comprising clay. In such an embodiment, the second cationic layer is disposed between the first cationic layer and the anionic layer. In another embodiment in which coating 65 comprises trilayers, the trilayers comprise a first cationic layer comprising polyethylenimine, an anionic layer comprising clay, and a second cationic layer comprising polyethylene oxide or polyglycidol. In such an embodiment, the anionic layer is disposed between the first cationic layer and the second cationic layer. In some embodiments in which coating 65 comprises trilayers, the trilayers comprise a cationic layer comprising polyethylene oxide or polyglycidol, a first anionic layer comprising polyacrylic acid or polymethacrylic acid, and a second anionic layer comprising sodium montmorillonite. In such an embodiment, the first anionic layer is disposed between the cationic layer and the second anionic layer.

In some embodiments, the multilayer thin film coating method includes rinsing rubber substrate 5 between each (or alternatively more than one) exposure step (i.e., step of exposing to cationic mixture or step of exposing to anionic mixture). For instance, after rubber substrate 5 is removed from exposure to the cationic mixture, rubber substrate 5 with first cationic layer 25 is rinsed and then exposed to an anionic mixture. In some embodiments, quadlayer 10 is rinsed before exposure to the same or another cationic and/or anionic mixture. In an embodiment, coating 65 is rinsed. The rinsing is accomplished by any rinsing liquid suitable for removing all or a portion of ionic liquid from rubber substrate 5 and any layer. In embodiments, the rinsing liquid includes deionized water, methanol, or any combinations thereof. In an embodiment, the rinsing liquid is deionized water. A layer may be rinsed for any suitable period of time to remove all or a portion of the ionic liquid. In an embodiment, a layer is rinsed for a period of time from about 5 seconds to about 5 minutes. In some embodiments, a layer is rinsed after a portion of the exposure steps.

In embodiments, the multilayer thin film coating method includes drying rubber substrate 5 between each (or alternatively more than one) exposure step (i.e., step of exposing to cationic mixture or step of exposing to anionic mixture). For instance, after rubber substrate 5 is removed from exposure to the cationic mixture, rubber substrate 5 with first cationic layer 25 is dried and then exposed to an anionic mixture. In some embodiments, quadlayer 10 is dried before exposure to the same or another cationic and/or anionic mixture. In an embodiment, coating 65 is dried. The drying is accomplished by applying a drying gas to rubber substrate 5. The drying gas may include any gas suitable for removing all or a portion of liquid from rubber substrate 5. In embodiments, the drying gas includes air, nitrogen, or any combinations thereof. In an embodiment, the drying gas is air. In some embodiments, the air is filtered air. The drying may be accomplished for any suitable period of time to remove all or a portion of the liquid from a layer (i.e., quadlayer 10) and/or coating 65. In an embodiment, the drying is for a period of time from about 5 seconds to about 500 seconds. In an embodiment in which the multilayer thin film coating method includes rinsing after an exposure step, the layer is dried after rinsing and before exposure to the next exposure step. In alternative embodiments, drying includes applying a heat source to the layer (i.e., quadlayer 10) and/or coating 65. For instance, in an embodiment, rubber substrate 5 is disposed in an oven for a time sufficient to remove all or a portion of the liquid from a layer. In some embodiments, drying is not performed until all layers have been deposited, as a final step before use.

In some embodiments (not illustrated), additives may be added to rubber substrate 5 in coating 65. In embodiments, the additives may be mixed in anionic mixtures with layerable materials. In other embodiments, the additives are disposed in anionic mixtures that do not include layerable materials. In some embodiments, coating 65 has a layer or layers of additives. In embodiments, the additives are anionic materials. The additives may be used for any desirable purpose. For instance, additives may be used for protection of rubber substrate 5 against ultraviolet light or for abrasion resistance. For ultraviolet light protection, any negatively charged material suitable for protection against ultraviolet light and for use in coating 65 may be used. In an embodiment, examples of suitable additives for ultraviolet protection include titanium dioxide, or any combinations thereof. In embodiments, the additive is titanium dioxide. For abrasion resistance, any additive suitable for abrasion resistance and for use in coating 65 may be used. In embodiments, examples of suitable additives for abrasion resistance include crosslinkers. Any crosslinker suitable for use with an elastomer may be used. In an embodiment, crosslinkers comprise a di-aldehyde. Examples of crosslinkers include glutaraldehyde, bromoalkanes, or any combinations thereof. The crosslinkers may be used to crosslink the anionic layers and/or cationic layers (i.e., first cationic layer 25 and first anionic layer 30). Without being limited by theory, crosslinking may extend the life of coating 65 and may make coating 65 resistant to abrasion or washing. In an embodiment, rubber substrate 5 with coating 65 is exposed to additives in an anionic mixture.

In some embodiments, the pH of the anionic and/or cationic solution is adjusted. Without being limited by theory, reducing the pH of the cationic solution reduces growth of coating 65. Further, without being limited by theory, the coating 65 growth may be reduced because the cationic solution may have a high charge density at lowered pH values, which may cause the polymer backbone to repel itself into a flattened state. In some embodiments, the pH is increased to increase the coating 65 growth and produce a thicker coating 65. Without being limited by theory, a lower charge density in the cationic mixture provides an increased coiled polymer. The pH may be adjusted by any suitable means such as by adding an acid or base. In an embodiment, the pH of an anionic solution is between about 0 and about 14, alternatively between about 1 and about 7. Embodiments include the pH of a cationic solution that is between about 0 and about 14, alternatively between about 3 and about 12.

The exposure steps in the anionic and cationic mixtures may occur at any suitable temperature. In an embodiment, the exposure steps occur at ambient temperatures. In some embodiments, coating 65 is optically transparent.

To further illustrate various illustrative embodiments of the present invention, the following examples are provided.

### Example 1

Materials. Natural sodium montmorillonite (MMT)(CLOISITE® NA+, which is a registered trademark of Southern Clay Products, Inc.) clay was used as received. Individual MMT platelets had a negative surface charge in deionized water, reported density of 2.86 g/cm³, thickness of 1 nm, and a nominal aspect ratio (l/d)≧200. Branched polyethylenimine (PEI) (M_{w}=25,000 g/mol and Mₙ=10,000 g/mol), polyethylene oxide (PEO) (M_{w}=4,000,000 g/mol) and polyacrylic acid (PAA) (35 wt. % in water, M_{w}=100,000 g/mol) were purchased from Sigma-Aldrich (Milwaukee, Wis.) and used as received. 500 μm thick, single-side-polished, silicon wafers were purchased from University Wafer (South Boston, Mass.) and used as reflective substrates for film growth characterization via ellipsometry.

Film Preparation. All film deposition mixtures were prepared using 18.21MΩ deionized water, from a DIRECT-Q® 5 Ultrapure Water System, and rolled for one day (24 h) to achieve homogeneity. DIRECT-Q® is a registered trademark of Millipore Corporation. Prior to deposition, the pH of 0.1 wt. % aqueous solutions of PEI were altered to 10 or 3 using 1.0 M HCl, the pH of 0.1 wt. % aqueous solutions of PEO were altered to 3 using 1.0 M HCl, the pH of 0.2 wt. % aqueous solutions of PAA were altered to 3 using 1.0 M HCl, and the pH of 2.0 wt. % aqueous suspensions of MMT were altered to 3 using 1.0 M HCl. Silicon wafers were piranha treated for 30 minutes prior to rinsing with water, acetone, water again and finally dried with filtered air prior to deposition. Rubber substrates were rinsed with deionized water, immersed in a 40 wt. % propanol in water bath at 40° C. for 5 minutes, rinsed with RT 40 wt. % propanol in water, rinsed with deionized water, dried with filtered air, and plasma cleaned for 5 minutes on each side. Each appropriately treated substrate was then dipped into the PEI solution at pH 10 for 5 minutes, rinsed with deionized water, and dried with filtered air. The same procedure was followed when the substrate was next dipped into the PAA solution. Once this initial bilayer was deposited, the above procedure was repeated when the substrate was dipped into the PEO solution, then the PAA solution, then the PEI solution at pH 3, and finally the MMT suspension, using 5 second dip times for polymer solutions and using one minute dip times for the MMT suspension, until the desired number of quadlayers of PEO/PAA/PEI/MMT were achieved. All films were prepared using a home-built robotic dipping system.

Film Characterization. Film thickness was measured every one to five quadlayers (on silicon wafers) using an ALPHA-SE® ellipsometer. ALPHA-SE® is a registered trademark of J.A. Woollam Co., Inc. OTR testing was performed by Mocon, Inc. in accordance with ASTM D-3985, using an Oxtran 2/21 ML instrument at 0% RH.

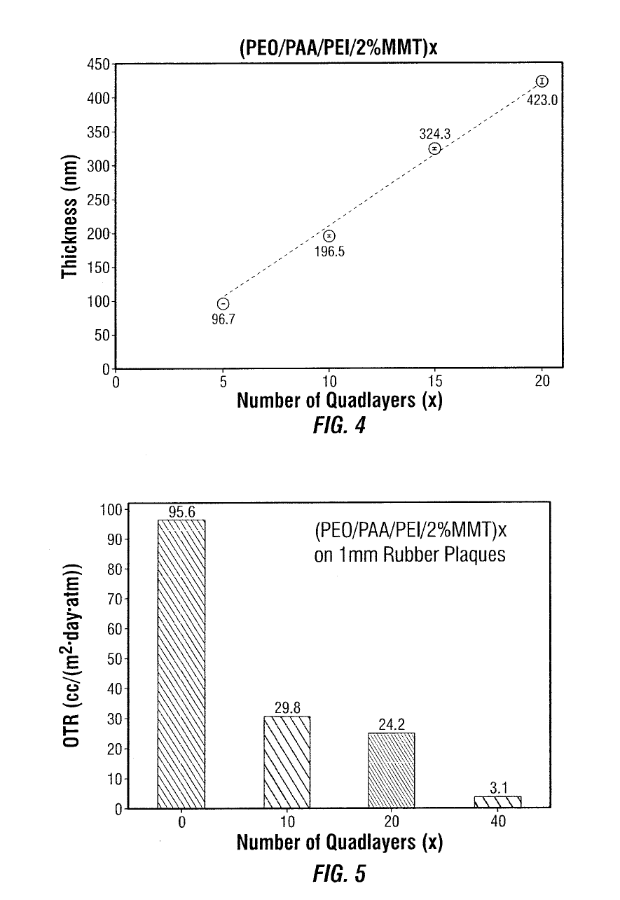

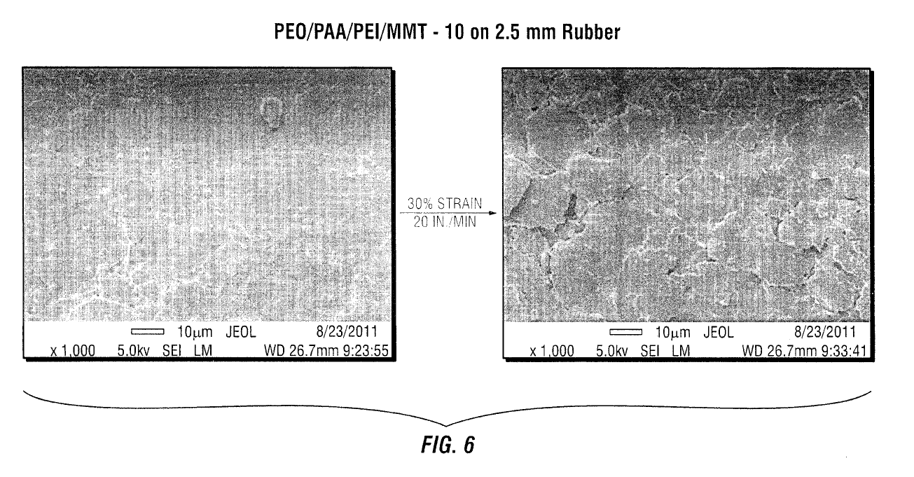

From the results, FIG. 4 illustrates thickness as a function of the number of quadlayers PEO/PAA/PEI/MMT when deposited on a silicon wafer and measured via ellipsometry. FIG. 5 illustrates results of oxygen transmission rate (OTR) as a function of the number of quadlayers of PEO/PAA/PEI/MMT when deposited on a 1 mm thick rubber plaque. FIG. 6 illustrates the elasticity of a coating of which the image on the left is 10 QLs on rubber, and the image on the right is the same coating stretched at 20 inches per minute to 30% strain. This right image showed no sign of mud-cracking and revealed the conformality of the coating to the stretched rubber surface.

Although the present invention and its advantages have been described in detail, it should be understood that various changes, substitutions and alterations may be made herein without departing from the spirit and scope of the invention as defined by the appended claims.

What is claimed is:

1. A method for producing a material diffusion barrier on a tire, comprising:
(A) exposing a surface of the tire to a cationic solution to produce a cationic layer on the surface; and
(B) exposing the cationic layer to an anionic solution to produce an anionic layer on the cationic layer, wherein a layer comprises the cationic layer and the anionic layer, and wherein the layer comprises the material diffusion barrier.

2. The method of claim 1, further comprising:
(C) exposing the anionic layer to a second cationic solution to produce a second cationic layer on the anionic layer, and wherein the layer comprises a trilayer comprising the cationic layer, the anionic layer, and the second cationic layer.

3. The method of claim 1, further comprising:
(C) exposing the anionic layer to a second cationic solution to produce a second cationic layer on the anionic layer; and
(D) exposing the second cationic layer to a second anionic solution to produce a second anionic layer on the second cationic layer, wherein the layer comprises a quadlayer comprising the cationic layer, the anionic layer, the second cationic layer, and the second anionic layer.

4. The method of claim 1, wherein the cationic solution comprises cationic materials, and wherein the cationic materials comprise a polymer, a colloidal particle, a nanoparticle, or any combinations thereof.

5. The method of claim 4, wherein the polymer comprises a polymer with hydrogen bonding, wherein the polymer with hydrogen bonding comprises polyethylene oxide, polyglycidol, polypropylene oxide, poly(vinyl methyl ether), polyvinyl alcohol, polyvinylpyrrolidone, polyallylamine, branched polyethylenimine, linear polyethylenimine, poly(acrylic acid), poly(methacrylic acid), copolymers thereof, or any combinations thereof.

6. The method of claim 1, wherein the anionic solution comprises layerable materials, and wherein the layerable materials comprise an anionic polymer, a colloidal particle, or any combinations thereof.

7. The method of claim 6, wherein the anionic polymer comprises a polystyrene sulfonate, a polymethacrylic acid, a polyacrylic acid, a poly(acrylic acid, sodium salt), a polyanetholesulfonic acid sodium salt, poly(vinylsulfonic acid, sodium salt), or any combinations thereof.

8. The method of claim 6, wherein the colloidal particle comprises a clay, a colloidal silica, an inorganic hydroxide, a silicon based polymer, a polyoligomeric silsesquioxane, a carbon nanotube, a graphene, or any combinations thereof.

9. The method of claim 1, wherein the tire further comprises a primer layer disposed between the surface and the cationic layer.

10. The method of claim 1, further comprising repeating steps (A) and (B) to produce a plurality of layers, wherein the material diffusion barrier comprises the plurality of layers.

11. A method for producing a material diffusion barrier on a tire, comprising:
(A) exposing a surface of the tire to an anionic solution to produce an anionic layer on the surface; and
(B) exposing the anionic layer to a cationic solution to produce a cationic layer on the anionic layer, wherein a layer comprises the anionic layer and the cationic layer, and wherein the layer comprises the material diffusion barrier.

12. The method of claim 11, further comprising:
(C) exposing the cationic layer to a second anionic solution to produce a second anionic layer on the cationic layer, and wherein the layer comprises a trilayer comprising the anionic layer, the cationic layer, and the second anionic layer.

13. The method of claim 11, further comprising:
(C) exposing the cationic layer to a second anionic solution to produce a second anionic layer on the cationic layer; and
(D) exposing the second anionic layer to a second cationic solution to produce a second cationic layer on the second anionic layer, wherein the layer comprises a quadlayer comprising the anionic layer, the cationic layer, the second anionic layer, and the second cationic layer.

14. The method of claim 11, wherein the cationic solution comprises cationic materials, and wherein the cationic materials comprise a polymer, a colloidal particle, a nanoparticle, or any combinations thereof.

15. The method of claim 14, wherein the polymer comprises a polymer with hydrogen bonding, wherein the polymer comprises polyethylene oxide, polyglycidol, polypropylene oxide, poly(vinyl methyl ether), polyvinyl alcohol, polyvinylpyrrolidone, polyallylamine, branched polyethylenimine, linear polyethylenimine, poly(acrylic acid), poly(methacrylic acid), copolymers thereof, or any combinations thereof.

16. The method of claim 11, wherein the anionic solution comprises layerable materials, and wherein the layerable materials comprise an anionic polymer, a colloidal particle, or any combinations thereof.

17. The method of claim 16, wherein the anionic polymer comprises a polystyrene sulfonate, a polymethacrylic acid, a polyacrylic acid, a poly(acrylic acid, sodium salt), a polyanetholesulfonic acid sodium salt, poly(vinylsulfonic acid, sodium salt), or any combinations thereof.

18. The method of claim 16, wherein the colloidal particle comprises a clay, a colloidal silica, an inorganic hydroxide, a silicon based polymer, a polyoligomeric silsesquioxane, a carbon nanotube, a graphene, or any combinations thereof.

19. The method of claim 11, wherein the tire further comprises a primer layer disposed between the tire and the anionic layer.

20. The method of claim 11, further comprising repeating steps (A) and (B) to produce a plurality of layers, wherein the material diffusion barrier comprises the plurality of layers.
